(19) United States
(12) Patent Application Publication
(10) Pub. No.: US 2011/0037616 A1
(43) Pub. Date: Feb. 17, 2011

(54) METHOD FOR MONITORING A TRAFFIC ROUTE FOR A MEANS OF TRANSPORT OF A PREDETERMINED KIND

(75) Inventors: Lutz Leutelt, Berlin (DE); Detlef Schnathmann, Kirchehrebach (DE); Hans Peter Thiel, Nurnberg (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, Muenchen (DE)

(21) Appl. No.: 12/988,137

(22) PCT Filed: Mar. 12, 2009
(86) PCT No.: PCT/EP2009/052891

§ 371 Date: Oct. 15, 2010

(30) Foreign Application Priority Data
Apr. 16, 2008 (EP) 08007465.1
Sep. 9, 2008 (EP) 08015882.7

(51) Int. Cl. G08G 5/06; H04R 29/00; G08G 1/00

(52) U.S. Cl. 340/901; 701/117; 381/56

(57) ABSTRACT

The embodiments relate to a method for monitoring a traffic route for a means of transport of a predetermined kind, particularly for an aircraft on a lane at an airport. The method involves noise signals that occur in a section of the traffic route (2) being recorded with a sound pickup (6, . . . , 13) and evaluated such that a piece of localization information is ascertained which indicates whether a means of transport (1) of the predetermined kind is in the section of the traffic route (2). If the piece of localization information reveals that a means of transport (1) of the predetermined kind is in the section, the admissibility of the means of transport (1) to be in the section is checked on the basis of one or more prescribed criteria, whereupon an appropriate checking result is output. The method according to the embodiments is distinguished in that the evaluation of noise signals can be used to achieve reliable localization of means of transport independently of weather conditions. In preferred embodiments, the piece of localization information can also contain the position of the means of transport in space, and it is also possible to obtain movement and/or classification information by evaluating the noise signals.

### CROSS REFERENCE TO RELATED APPLICATIONS

This application is the U.S. national stage of International Application No, PCT/EP2009/052891, filed Mar. 12, 2009 and claims the benefit thereof. The International Application claims the benefit of European Application No. 08007465, filed on Apr. 16, 2008, and European Application No. 08015882, filed Sep. 9, 2008, all applications are incorporated by reference herein in their entirety.

### BACKGROUND

1. Field

The embodiments relate to a method for monitoring a traffic route for a means of transport of a predetermined kind, in particular for an aircraft on a lane or taxiway at an airport.

2. Description of the Related Art

The problem frequently arises on traffic routes that means of transport are present and move on these traffic routes without authorization. This can lead to serious accidents, since other means of transport do not allow for the presence of the unauthorized means of transport on the traffic route. Especially at airports, it happens that aircraft are present without authorization on such lanes, in particular on the takeoff or landing runway and on taxiways leading to the access point to the takeoff runway. In order to regulate the access point to the takeoff runway, only indicator units in the form of so-called wigwags and so-called stop bars are provided on the taxiways. The stop bars take the form of flush lights in the taxiways, over which, however, aircraft can pass. If a taxiway or, in some cases, another lane at the airport is being incorrectly used by the aircraft as a result of pilot error, the pilot receives no notification of his incorrect action. The error can only be ascertained by the staff of the control tower, with the risk that the error is seen too late or is overlooked by the control tower personnel. Consequently, the pilot is informed too late, or not at all, about his incorrect action and, as a result, accidents, in particular collisions with other aircraft, can, under some circumstances, no longer be prevented.

### SUMMARY

The problem frequently arises on traffic routes that means of transport are present and move on these traffic routes without authorization. This can lead to serious accidents, since other means of transport do not allow for the presence of the unauthorized means of transport on the traffic route. Especially at airports, it happens that aircraft are present without authorization on such lanes, in particular on the takeoff or landing runway and on taxiways leading to the access point to the takeoff runway. In order to regulate the access point to the takeoff runway, only indicator units in the form of so-called wigwags and so-called stop bars are provided on the taxiways. The stop bars take the form of flush lights in the taxiways, over which, however, aircraft can pass. If a taxiway or, in some cases, another lane at the airport is being incorrectly used by the aircraft as a result of pilot error, the pilot receives no notification of his incorrect action. The error can only be ascertained by the staff of the control tower, with the risk that the error is seen too late or is overlooked by the control tower personnel. Consequently, the pilot is informed too late, or not at all, about his incorrect action and, as a result, accidents, in particular collisions with other aircraft, can under some circumstances no longer be prevented.

It is therefore an aspect of the embodiments to provide a method and an apparatus for monitoring a traffic route for a means of transport of a predetermined kind which ensure reliable and automatic recognition of a means of transport which is inadmissibly present or moving on the traffic route.

In the method according to the embodiments noise signals occurring in a section of the traffic route to be monitored are detected with a sound pickup. These noise signals are then evaluated in such a manner that localization information is ascertained which indicates whether a means of transport of the predetermined kind is present in the section of the traffic route. Finally, in the event that, according to the localization information, a means of transport of the predetermined kind is present in the section, the admissibility of the presence of the means of transport in the section is checked on the basis of one or more prescribed criteria, whereupon an appropriate checking result is output.

The method according to the embodiments is used especially preferably for monitoring traffic routes of aircraft on lanes at an airport. In particular, the taxiways leading to a takeoff and or landing runway, and/or the takeoff and/or landing runway itself, as well as the parking positions of the aircraft at the airport, are monitored. A parking position therefore also represents a traffic route within the meaning of the embodiments. In the detection of acoustic noises of aircraft, the aircraft is localized in particular on the basis of the aircraft engine noises and other sound radiations typical of aircraft. Optionally, the method according to the embodiments may also be used for other means of transport, for example motor vehicles on roadways or rail vehicles on railways.

The method according to the embodiments is distinguished in that a means of transport of a predetermined kind is localized by means of acoustic noise recognition. This type of localization has the advantage that it also operates reliably in poor weather conditions, which is not the case with localization based on other technologies, for example radar.

For the acoustic recognition of the means of transport of the predetermined kind, noise recognition methods sufficiently known from the prior art, which are trained in advance with corresponding noises of the means of transport of the predetermined kind, may be used. In particular, statistical classification methods for classifying the noise signals may be used. For example, the sensor apparatus for detecting and evaluating noise signals described in the German patent application DE 10 2007 044 407.0 may be used. In a first operating mode, this sensor apparatus carries out a noise recognition method, it being possible to train the noise recognition method in a second operating mode. Likewise, the noise recognition method according to the German patent application DE 10 2008 021 362.4 may be used in the method according to the embodiments. In this noise recognition, the model is automatically adapted to the acoustic environment on the basis of a statistical basic classification model. The entire disclosed content of the two above-mentioned patent applications is incorporated by reference in the content of the present application.

In a further, especially preferred embodiment, the prescribed criterion or criteria, on which the admissibility of the presence of the means of transport of the predetermined kind depends, take account of the current traffic situation, in particular, of information on the current takeoff and landing times of aircraft at an airport. Account is thereby taken of the fact that the traffic situation changes dynamically, especially at airports, so that the admissibility criteria for the presence of a means of transport in certain areas must be adapted dynamically.

In a further embodiment, noise signals within a frequency range of substantially 1 to 4 kHz, or in a partial band lying within this frequency range, are monitored with the method according to the embodiments. This frequency range substantially encompasses the noises generated by an aircraft, in particular the corresponding turbine noises of aircraft.

In a preferred embodiment, the noise signals are detected with a sound pickup including one or more individual acoustic pickups, preferably in the form of microphones. In this case, the acoustic pickups may be positioned in any desired manner on or in the traffic route. In particular, the acoustic pickups may be arranged laterally beside the traffic route, for example laterally beside a taxiway, and/or in the traffic route, for example in one or more lights in a taxiway.

In an especially preferred embodiment, the noise signals are detected with one or more microphone arrays. As a microphone array, a linear microphone array, in which the microphones are arranged along one or more straight or optionally curved lines, may, for example, be used. In this case the lines are, in particular, parallel to the direction of the traffic route, ensuring especially efficient detection of the sound. Optionally, radial microphone arrays, in which the microphones are arranged in a substantially circular formation, may also be used. Such radial microphone arrays allow unequivocal determination of the direction from which the noise signals are received. Microphone arrays in which the distance between adjacent microphones is substantially from 3 to 4 cm have proved especially suitable for the method according to the embodiments. The microphone arrays may comprise any desired number of microphones; arrays with 4 to 8 microphones are preferably used. Instead of, or in addition to, the microphone arrays, directional microphones with a predetermined directional characteristic may optionally be used.

According to the embodiments, various parameters of the noise signals may be evaluated in order to localize the means of transport of a predetermined kind. In particular, one or more of the following parameters of the noise signals may be used:
differences in runtimes and/or phases of the noise signals;
the direction-dependent damping of the noise signals;
the distance-dependent damping of the noise signals; and
the distance-dependent acoustic characteristic of the noise signals.

In this case the acoustic characteristic is appropriately classified using suitable classification methods. In particular, statistical classification methods sufficiently known from the prior art are used for this purpose.

On the basis of the above-mentioned parameters, it is possible to determine the direction and the distance of the means of transport with respect to individual acoustic pickups, and thereby the exact position of the means of transport, using methods known per se.

In a preferred variant, the Doppler effect, whereby the direction of movement of a means of transport can be determined, is also taken into account in evaluating the noise signals. Furthermore, the evaluation of the noise signals is preferably carried out in such a manner that, as localization information, the spatial position of the means of transport is also ascertained and optionally output and further processed.

In a further configuration of the method according to the embodiments, motion information indicating the speed at which and/or the direction in which a means of transport present in the section of the traffic route is moving, is also acquired, in addition to the localization information, in the evaluation of the noise signals, this motion information optionally being output and/or further processed.

In a further embodiment of the method use is made, in the evaluation of the noise signals, of a classification method, in particular a statistical classification method, which classifies the noise signals according to the type of means of transport, from a large number of predetermined types, from which they originate, whereby corresponding classification information is acquired and optionally is output and/or further processed. In a preferred variant, the large number of predetermined types includes one or more aircraft types and/or one or more aircraft tractors, since the presence of an aircraft can in some circumstances also be ascertained via the noise signals of a tractor which is towing the aircraft on the traffic route monitored.

The above-described motion and/or classification information may be taken into account in checking the admissibility of the presence of the means of transport of a predetermined kind in the section of the traffic route. For example, traveling on a traffic route may be permitted only to one predetermined type of means of transport and may be inadmissible for other types. Accordingly, the admissibility of the presence of the means of transport may also be ascertained by taking account of the type determined. Likewise, certain movements of the means of transport, for example away from a takeoff runway onto a taxiway, may be non-critical and therefore admissible, which may also be taken into account in checking admissibility.

In a further configuration of the method according to the embodiments, one or more measures for warning one or more persons controlling the means of transport, and/or for intervening in the movement of the means of transport, may be carried out in the event that the admissibility of the presence of the means of transport of the predetermined kind in the section of the traffic route is ascertained according to the checking result. These measures may include the following measure:
outputting an optical and/or acoustic warning message, especially on a signaling unit on the traffic route (for example, on a wigwag or a stop bar), and/or on a signaling unit in the means of transport, it being possible for the signaling information to be transmitted, for example wirelessly, to the means of transport and to be reproduced on the signaling unit in the means of transport.

In a further preferred embodiment, account is taken, in the evaluation of the noise signals, of further signals for localizing the means of transport which are detected via one or more further sensors, in particular signals which are detected via one or more video cameras and/or via one or more radar sensors and/or via one or more light barriers. In this way of the accuracy of the localization can be increased.

In addition to the above-described method, the invention further includes an apparatus for monitoring a traffic route for a means of transport of a predetermined kind, in particular for an aircraft on a lane at an airport, comprising:
a sound pickup for detecting noise signals occurring in a section of the traffic route;
an evaluation unit which evaluates the noise signals detected in operation in such a manner that localization information is acquired which indicates whether a means of transport of the predetermined kind is present in the section of the traffic route and, in the event that, according to the localization information, a means of transport of the predetermined kind is present in the section, the admissibility of the presence of the means of transport in the section is checked on the basis of one or more prescribed criteria and an appropriate checking result is output.

The apparatus is preferably configured in such a manner that each variant of the above-described method according to the embodiments can be carried out with the apparatus.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic representation of an embodiment of an apparatus for monitoring a taxiway at an airport;

FIG. 2 is a schematic representation of the spatial relationships between a microphone array and an aircraft on a traffic route in order to illustrate the determination of the position of the aircraft according to a variant;

FIG. 3 is a schematic representation reproducing the sequence of an embodiment of the method, and the components used therein.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The preferred application of the method according to the embodiments is the monitoring of lanes at airports in order to locate aircraft moving or present on incorrect lanes via the detection of noise signals. In the embodiment described herein, upon detection of inadmissibly positioned aircraft corresponding countermeasures are initiated and, in particular, the pilot is appropriately warned.

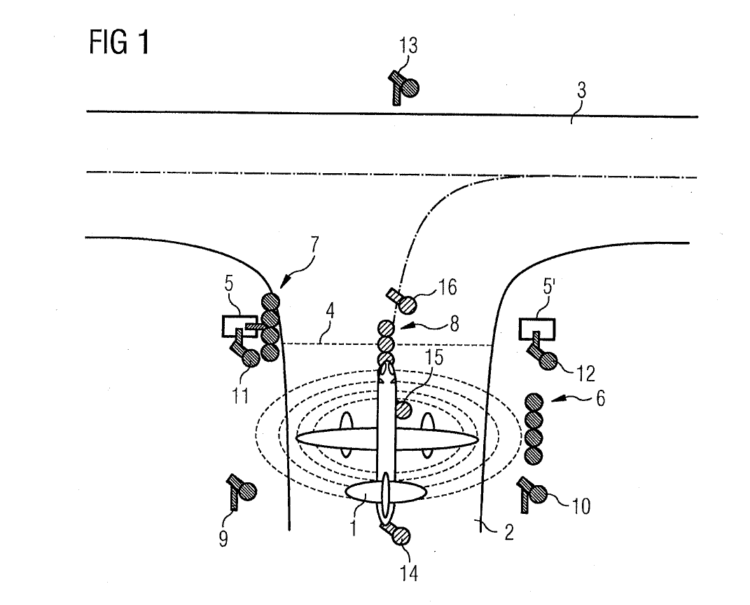

FIG. 1 shows in a schematic representation and in a top view a scenario in which an aircraft 1 is present on a taxiway 2 which gives access to a corresponding takeoff runway 3. The sound propagated from the aircraft is indicated in FIG. 1 by a plurality of concentrically arranged ellipses in the region of the aircraft. A stop line at which the aircraft waits until it receives permission to start from the control tower of the airport is provided at the front end of the taxiway, as a suitable marking 4. So-called wigwags (runway guard lights) 5 and 5′, indicated schematically as rectangles, are arranged on the left and right beside the taxiway, laterally level with the stop line 4. These wigwags represent signaling units for the pilot in the aircraft and give various messages via optical lights; in particular, it is also indicated whether the aircraft can travel on the takeoff runway.

It sometimes happens at airports that an aircraft uses the incorrect taxiway as an access way to the takeoff runway or leaves the taxiway too early, without authorization, in order to travel on the takeoff runway. This occurs, in particular, in conditions of poor visibility through weather influences, in which, for example, pilots overlook appropriate stop bars. A safety-relevant problem which can lead to serious accidents therefore arises. At present, monitoring of an incorrectly used taxiway or an unauthorized entry to the takeoff runway is carried out only by the personnel in the control tower of the airport. This monitoring carries the risk that the personnel discover the pilot's incorrect action too late, and that the reaction time for warning the pilot is too long to avert a possible accident. In the worst case it may also happen that the control tower staff completely overlook the incorrect action of the pilot.

In order to circumvent the above-described safety problem, it is proposed according to the embodiment in FIG. 1 to arrange a plurality of sound pickups in the form of microphones at various positions in the region of the taxiway. It can then be determined via the detection of the aircraft sound by the microphones, and by a subsequent evaluation, whether an aircraft is present on the taxiway and in which direction and at which speed it is moving on this taxiway. On the basis of such detection, a separate warning message can be communicated to the aircraft pilot by means of special signal lights, in particular using the stop bars mentioned in the introduction, if access by the aircraft to the taxiway is not admissible. Preferably, the detection of an aircraft on the taxiway is transmitted to a central computing unit which also has access to data on the current flight operations and the infrastructure of the airport. With the aid of this data it can then be determined whether the position of the aircraft on the taxiway is admissible. The method can also be applied to other traffic routes at the airport, in particular to monitoring a takeoff or landing runway or corresponding parking positions of the aircraft.

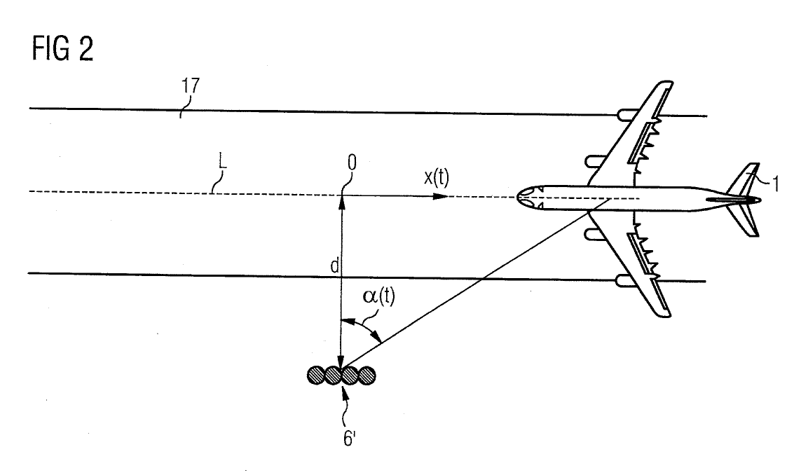

In the embodiment of FIG. 1 various arrangements of microphones are shown. Firstly, a linear microphone array 6 comprising four individual microphones is provided on the right beside the taxiway 2 level with the wings of the aircraft 1. A corresponding microphone array 7 is also arranged on the left side of the taxiway in the region of the stop line 4. In addition to the laterally installed microphone arrays, a further microphone array 8, which also comprises a linear array of four microphones, is provided in the surface of the taxiway level with the stop line 4. The microphone array 8 is recessed in the surface of the taxiway 2 and therefore does not obstruct movement of the aircraft. Optionally, the lights usually present in the taxiway may be used for integration of the appropriate microphone arrays therein. By means of the microphone arrays, the angular position of a sound source—that is, of the aircraft 1 in the case of FIG. 1—is ascertained and the spatial position of the aircraft is determined therefrom with the aid of information on the geometry of the taxiway. In addition, the speed of the aircraft can also be ascertained. The determination of the position and speed by means of a suitable microphone array is explained below with reference to FIG. 2.

In addition to the microphone arrays, directional microphones 9 to 12 are arranged laterally beside the taxiway. The microphones 9 and 10 are positioned at the level of the rear end of the aircraft, whereas the microphones 11 and 12 are arranged on the wigwags 5, 5′ respectively, level with the stop line. In addition, a further directional microphone 13 is arranged at the side of the takeoff runway 3 level with the taxiway, in order to capture frontal sound. In addition to the laterally arranged microphones 9 to 13, directional microphones denoted by reference numerals 14, 15 and 16 are provided on the taxiway. These directional microphones are recessed in the surface of the taxiway analogously to the microphone array 8, it again being possible to use the lights in the taxiway for integration of the microphones. The individual directional microphones have a directional characteristic with a corresponding main beam. If the noise signal detected by the respective microphone arrays and directional microphones exceeds a predetermined threshold value, the direction from which the sound comes can be inferred therefrom, whereby the position of the aircraft can be determined. Through the use of a plurality of directional microphones and microphone arrays, precise determination of position can be achieved by calculation and merging of the measurement data of all the microphones. The sound frequencies detected by means of the microphone arrays and directional microphones lie in a frequency range within which the usual engine noises of aircraft lie. The frequency range may include the range audible to human beings and in some cases also a non-audible range (for example, ultrasound or infrasound). Likewise, microphones may also be replaced by sound pickups in the form of vibration sensors.

The arrangement of the individual microphones and microphone arrays according to FIG. 1 is merely an example, and different arrangements may be provided for localizing the aircraft via the detection of noise signals. In particular, further microphones and microphone arrays may be used, or optionally some of the microphones or parts of microphone arrays may be omitted or arranged at different positions. Optionally, microphone arrays and directional microphones may be arranged on suitable sign boards on the taxiway or on supports specifically provided for the microphones. If the microphone arrays or directional microphones are integrated in the ground surface, appropriate measures should be taken to ensure that the operation of the microphones is not impaired by snowfall. For example, a suitable heating unit for melting snow in the region of the microphones might be provided.

An aircraft can be localized by the directional microphones via the directional characteristic, that is, the direction-dependent damping, thereof. A corresponding, variable directional characteristic is also generated for the microphone arrays by phase shifts, and is used for localization, as is described below. In addition, runtime differences of the aircraft sound can be determined for the purpose of localization. Likewise, the distance of the aircraft from the individual microphones, and thereby a parameter for the position of the aircraft, can be determined via the distance-dependent damping of the aircraft sound. Furthermore, classification and evaluation methods known from the prior art, which determine the position of an aircraft via distance-dependent sound properties thereof, may be used for localizing the aircraft. With a suitably trained statistical classification method it can also be ascertained which type of aircraft is present on the taxiway. This information may optionally be further processed, since under some circumstances the case may arise that an aircraft which wants to move onto a takeoff runway is unsuitable to take off on this runway because of its type, since the length of the runway is insufficient for the aircraft to achieve lift-off on account of its size. The possible variants for localizing an aircraft just described may be combined with one another in a suitable manner in order to increase robustness.

FIG. 2 shows by way of example how an aircraft 1 on a traffic route 17 can be localized with the aid of a microphone array 6′ which has the same construction as the microphone array 6 of FIG. 1. In operation, the environment oriented towards the traffic route is scanned by the microphone array within a 180° range, in that phase signals to the individual microphones of the array are added, for example, by a computer, whereby the directional characteristic of the array is changed. That is to say that the array changes the direction in which it can “hear” sound. Acoustic noises from the direction in which the microphone array is listening at a given time are constructively added according to the phase shifts of the microphones, and a corresponding maximum is yielded. For effective localization of sound maxima for aircraft sound, a microphone distance of 3 to 4 cm between the microphones of the array 6′ has proved practical.

By means of the scanning of the microphone array explained above, therefore, the angle from which a sound maximum is received can be determined. In FIG. 2 this is the angle α(t), which depends on the time t, since, in the scenario represented, the aircraft is moving at a constant speed v. The actual position of the aircraft x(t), which is measured towards the right along the center line L of the lane 17, starting from the origin O, is derived, with the aid of the distance d of the microphone array 6′ from the center line L, as follows:

α(t)=tan⁻¹(x(t)/d)=tan⁻¹(v/d·t)

The position of the aircraft can therefore also be localized by a microphone array via the determination of the angle α from which a maximum of sound is received. Furthermore, through the time-dependent change of the angle α(t), which can also be detected by the microphones, the speed of the aircraft can also be estimated. The estimated speed \hat{v} is yielded by the change of the angle over time and the actual angular position as follows:

$$\hat{v} = d \cdot [ 1 + {[ tan ( α ( t ) ) ]}^{2} ] \frac{d}{d t} α ( t )$$

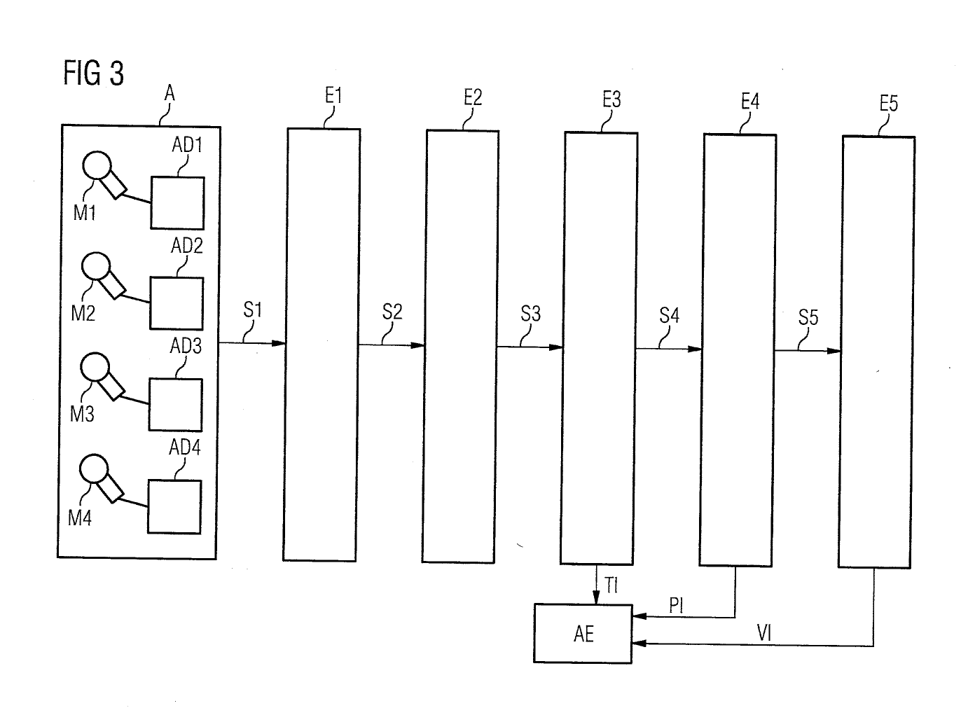

Through the use of further microphone arrays or directional microphones, the accuracy of the localization can be further improved. In addition, the possibility exists to classify the sound more closely in order to determine the type of aircraft from which the sound originates. A corresponding embodiment which carries out such a classification of the sound is described below with reference to FIG. 3.

FIG. 3 shows in a schematic representation, firstly, a sound transducer A in the form of a microphone array including individual microphones M1 to M4. The sound, which has been acquired in analog form by the microphones M1 to M4, is digitized in the sound transducer A with the aid of individual analog-digital converters AD1 to AD4, which are each associated with a respective microphone M1 to M4. Next, the further steps S1 to S5, which may be carried out by a computer or dedicated processing units, are carried out as indicated by corresponding arrows. As is indicated by step S1, the digitized noise signal is further processed in a unit E1, an appropriate weighting of the signals of the microphones being performed in this unit, depending on the application. Optionally, the processing by the unit E1 may be omitted. In a next step S2, the processed signal is supplied to a unit E2 which ascertains, on the basis of the signals of the microphones, whether a noise signal that might correspond to an aircraft is actually present. This is effected, for example, by comparison of the loudness level of the noise signals detected with a threshold value. If the threshold value is exceeded, it is concluded that an aircraft has been detected by the sound pickup A. Alternatively, a classification of the noise signals may be carried out in addition to the threshold value, in order to ensure that an aircraft is actually responsible for the noise which is above the threshold value.

Then, in a step S3, a classification method is carried out in a corresponding classification module E3, in order to determine the type of aircraft from which the noise signal originates. In particular, a statistical classification method is used in this case. Such classification methods are sufficiently known from the prior art and, in the present application, define a class-membership of the noise data captured with reference to training data, that is, from feature distributions of noise signals which have been previously recorded and which correspond to the noise signals of particular aircraft types. The detection and classification of the noise signals may be carried out, for example, on the basis of a sensor device which is described in the German patent application DE 10 2007 044 407.0. The classificator E3 used in this case was taught using training data originating from corresponding field trials with different aircraft types. Because the noise signals may behave differently at different airports, in a preferred embodiment the classificator is re-adapted to the conditions of the airport concerned in operation at this airport. This adaptation is carried out, in particular, on the basis of the method described in the German patent application DE 10 2008 021 362.4.

In step S4, after the classification of the aircraft type, the determination of the position of the aircraft, based, for example, on the method explained with reference to FIG. 2, is carried out in a further processing unit E4. Finally, in a further unit E5, the speed is calculated, the method used with reference to FIG. 2 also being employed. The data acquired by the units is supplied to a common evaluation unit AE. In particular, the information TI on the aircraft type, the information PI on the position of the aircraft and the information VI on the speed of the aircraft are evaluated in the evaluation unit AE. In this case the evaluation unit may constitute a central flight management system type computer system which has access to current data on the flight operation and the airport infrastructure. Finally, a comparison is carried out between the reference expectation for the position of a corresponding aircraft type and the actual value of the position actually determined. If the actual value deviates from the reference value, a corresponding signaling operation is carried out; in particular, the pilot is warned by optical or acoustic signals, for example by appropriate signaling on specific signal lights of a taxiway. In particular, the above-described stop bars on the taxiway may be switched on as countermeasures.

The individual units E1 to E5 described with reference to FIG. 3 are functional modules which execute predetermined calculation steps. These modules do not need to be in the form of separate units but may be integrated in a combined module and, in particular, are implemented by means of suitable software executed by a computer.

In a further configuration of the method according to the embodiment, further position data from other sensors, such as microwave sensors, contact loops and the like, may be merged with the remaining data in the evaluation unit AE in order to increase the accuracy of the localization.

As is apparent from the preceding discussion, safety at airports can be increased with the embodiment described, since pilots can be warned when inadmissibly traveling on taxiways, when inadmissibly leaving taxiways and when inadmissibly entering taxiways. This is effected with the aid of acoustic noise recognition of the aircraft, that is, especially of the turbine noises of the aircraft. The noise recognition may optionally also be configured in such a manner that tractors towing the aircraft on the airport site are recognized in addition to or instead of aircraft. If a tractor is localized, the presence of an aircraft is inferred therefrom. The acoustic noise recognition according to the embodiments has the advantage, as compared to other sensors, that it also makes possible operation in conditions of poor visibility, which is not ensured in the case of radar sensors, for example.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-23. (canceled)

24. A method for monitoring a traffic route for a means of transport of a predetermined kind, in particular for an aircraft on a lane at an airport, comprising:
detecting noise signals occurring in a section of the traffic route with a sound pickup;
evaluating the noise signals detected in such a manner that localization information is obtained which indicates whether the means of transport of the predetermined kind is present in the section of the traffic route; and
checking, if a means of transport of the predetermined kind is present in the section according to the localization information, admissibility of the presence of the means of transport in the section on the basis of one or more prescribed criteria and an appropriate checking result is output.

25. The method as claimed in claim 24, wherein a taxiway at the airport and/or the takeoff runway and/or the landing runway at the airport and/or a parking position at the airport are monitored.

26. The method as claimed in claim 24, wherein the prescribed criterion or criteria take account of the current traffic situation, in particular of information on current takeoff and landing times of aircraft at the airport.

27. The method as claimed in claim 24, wherein the noise signals within a frequency range from substantially 1 to 4 kHz, or in a partial band lying within this frequency range, are monitored.

28. The method as claimed in claim 24, wherein the noise signals are detected with a sound pickup comprising one or more individual sound pickups, in particular in the form of microphones.

29. The method as claimed in claim 28, wherein the sound pickup or pickups are arranged laterally beside the traffic route, in particular laterally beside a taxiway, and/or in the traffic route, in particular in one or more lights in a taxiway.

30. The method as claimed in claim 28, wherein the noise signals are detected with one or more microphone arrays.

31. The method as claimed in claim 30, wherein at least one microphone array is a linear microphone array in which the microphones are arranged along one or more lines.

32. The method as claimed in claim 30, wherein at least one microphone array is a radial microphone array in which the microphones are arranged in a substantially circular formation.

33. The method as claimed in claim 30, wherein a distance between adjacent microphones in the microphone array is substantially from 3 to 4 cm.

34. The method as claimed in claim 28, wherein the noise signals are detected with at least one directional microphone.

35. The method as claimed in claim 24, wherein, during the evaluating, the means of transport of the predetermined kind is localized in the section of the traffic route on the basis of one or more of the following parameters of the noise signals:
runtime differences and/or phase differences in the noise signals;
a direction-dependent damping of the noise signals;
a distance-dependent damping of the noise signals; and
a distance-dependent acoustic characteristic of the noise signals.

36. The method as claimed in claim 24, wherein account is taken of a Doppler effect in the evaluation of the noise signals.

37. The method as claimed in claim 24, wherein a spatial position of the means of transport is also determined as localization information.

38. The method as claimed in claim 24, wherein movement information indicating a speed at which and/or a direction in which the means of transport present in the section of the traffic route is moving is also determined.

39. The method as claimed in claim 24, wherein, during the evaluating, use is made of a classification method, in particular a statistical classification method, which classifies the noise signals according to a type of means of transport, from a large number of predetermined types, from which they originate, whereby corresponding classification information is acquired.

40. The method as claimed in claim 39, wherein the large number of predetermined types includes one or more aircraft types and/or one or more tractors for aircraft.

41. The method as claimed in claim 38, wherein, in the checking, the movement information and/or classification information is taken into account in checking the admissibility of the presence of the means of transport of the predetermined kind in the section of the traffic route.

42. The method as claimed in claim 24, wherein, in an event that in the checking the inadmissibility of the presence of the means of transport of the predetermined kind in the section of the traffic route is ascertained according to the checking result, one or more measures for warning one or more persons controlling the means of transport, and/or for intervening in the movement of the means of transport, are carried out.

43. The method as claimed in claimed 42, wherein the measures comprise outputting of an optical and/or acoustic warning message, in particular on a signaling unit on the traffic route and/or on a signaling unit in the means of transport.

44. The method as claimed in claim 24, wherein, during the evaluating, signals for localizing the means of transport detected via one or more further sensors, in particular signals detected via one or more video cameras and/or via one or more radar sensors and/or via one or more light barriers, are taken into account.

45. An apparatus for monitoring a transport route for a means of transport of a predetermined kind, in particular for an aircraft on a lane at an airport, comprising:
a sound pickup microphone for detecting noise signals occurring in a section of the traffic route;
an evaluation unit which evaluates the noise signals detected in operation in such a manner that localization information is obtained which indicates whether the means of transport of the predetermined kind is present in the section of the traffic route, and, in an event that the means of transport is present in the section according to the localization information, admissibility of the presence of the means of transport of the predetermined kind in the section is checked on the basis of one or more prescribed criteria and an appropriate checking result is output.

46. The apparatus as claimed in claim 45, wherein the apparatus is configured in such a manner that a method according to claim 25 can be carried out with the apparatus.

47. A non-transitory computer readable storage for controlling a computer and storing a method for monitoring a traffic route for a means of transport of a predetermined kind, in particular for an aircraft on a lane at an airport, the method comprising:
obtaining noise signals occurring in a section of the traffic route detected by a sound pickup;
evaluating the noise signals to obtain localization information which indicates whether the means of transport of the predetermined kind is present in the section of the traffic route; and
checking, if a means of transport of the predetermined kind is present in the section, the admissibility of the presence of the means of transport in the section on the basis of one or more prescribed criteria and outputting an appropriate checking result.
